(19) United States
(12) Patent Application Publication
(10) Pub. No.: US 2009/0030742 A1
(43) Pub. Date: Jan. 29, 2009

(54) System and Method for Tentative Booking When Service Providers are Temporarily Unavailable

(75) Inventors: Mark ORTTUNG, Menlo Park, CA (US); Timothy A. MILLER, San Francisco, CA (US); Brian GODDEN, Los Gatos, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 11/829,824

(22) Filed: Jul. 27, 2007

(51) Int. Cl. G06Q 50/00

(52) U.S. Cl. 705/5

(57) ABSTRACT

One embodiment provides a method, that may be implemented on a system, for receiving a request from a user to perform at least one of schedule an event or book a transaction; selecting a service provider to schedule the event or book the transaction; contacting the selected service provider to schedule the event or book the transaction; in response to at least one of failure to establish a connection with the selected service provider or failure to receive a response from the selected service provider, notifying the user of the failure and requesting the user submit transaction data to schedule the event or book the transaction with the service provider at a subsequent time; and subsequent to receiving the transaction data from the user, establishing a connection with the selected service provider and using the received transaction data to schedule the event or book the transaction with the selected service provider.

### BACKGROUND OF THE INVENTION

Often, for various reasons, some within and some beyond the control of a traveler or a business person, appointments cannot be kept on time. For example, a traveler may be victim of transportation system delays. In other cases, a delay at an appointment may be due to a meeting that is important and cannot be cut short running past its anticipated ending time. In any case, appointments and meeting times are often wasted when one party does not attend, resulting in, at the least, annoyance and inconvenience for the other attendee(s), and sometimes resulting in more serious damaging consequences.

In some cases, a GPS-dependent method and system known to the inventor may be used to notify other parties and to adjust schedules as needed. In other cases, however, the traveler does not have a GPS phone, and therefore using the system of the previously cited invention is not possible. However, most business people traveling today have the ability to make a phone call, to send an email or an SMS, or to communicate with a digital system by some electronic means.

In addition, often a person has only a limited time to deal with planning and arranging for travel and events; however, it can and sometimes does happen that when a person, such as, for example, a business traveler on a layover between transit legs, attempts to transact the scheduling or rescheduling of events, the service provider he needs to contact is not available, due to failures and break-downs in a communication means. For example, there may be connectivity problems, data center problems, denial-of-service attacks, and so forth. The traveler, however, may be pressed for time and must make transactions at this time, because soon he will be out of contact for some time.

What is clearly needed is system and method that can accept the transaction request at the time a person can make it, and then later the system can contact the necessary service provider(s) when it or they become available, to complete the transactions.

### DESCRIPTION OF THE EMBODIMENTS

The disclosure is illustrated by way of example and not limitation in the figures of the accompanying drawings in which like references indicate similar elements

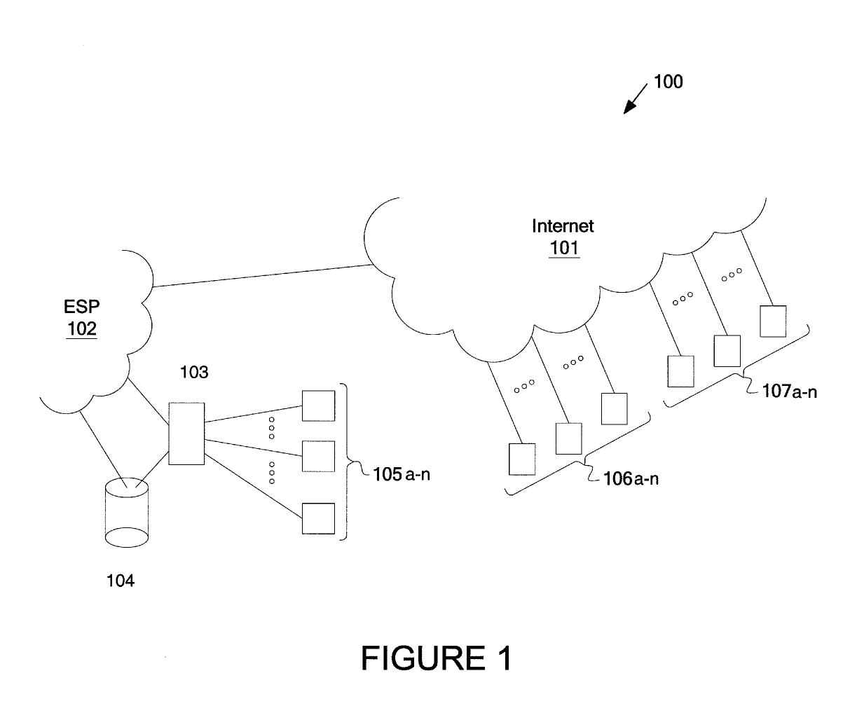

FIG. 1 shows an exemplary overview of a system 100 according to one embodiment of the current invention;

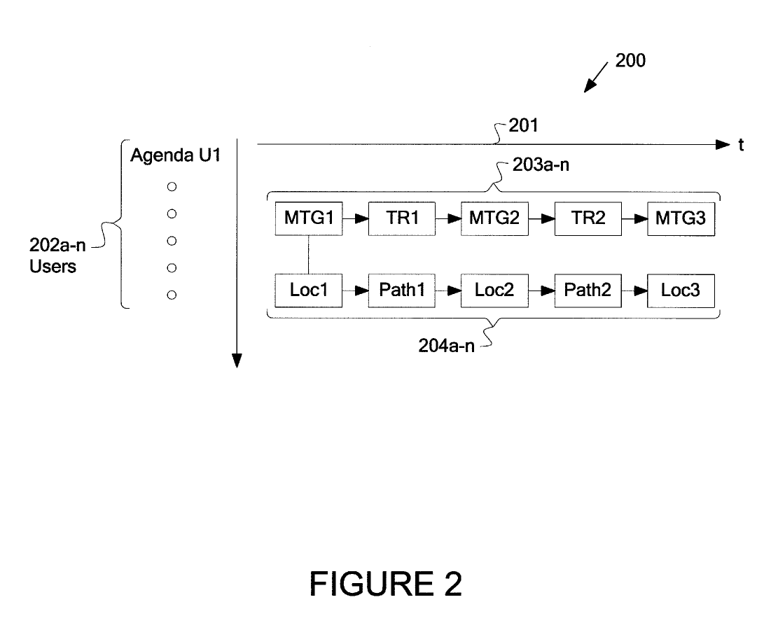

FIG. 2 shows an exemplary overview of a calendar system 200, such as would reside in a PIM or PIM database of many users 202a-n;

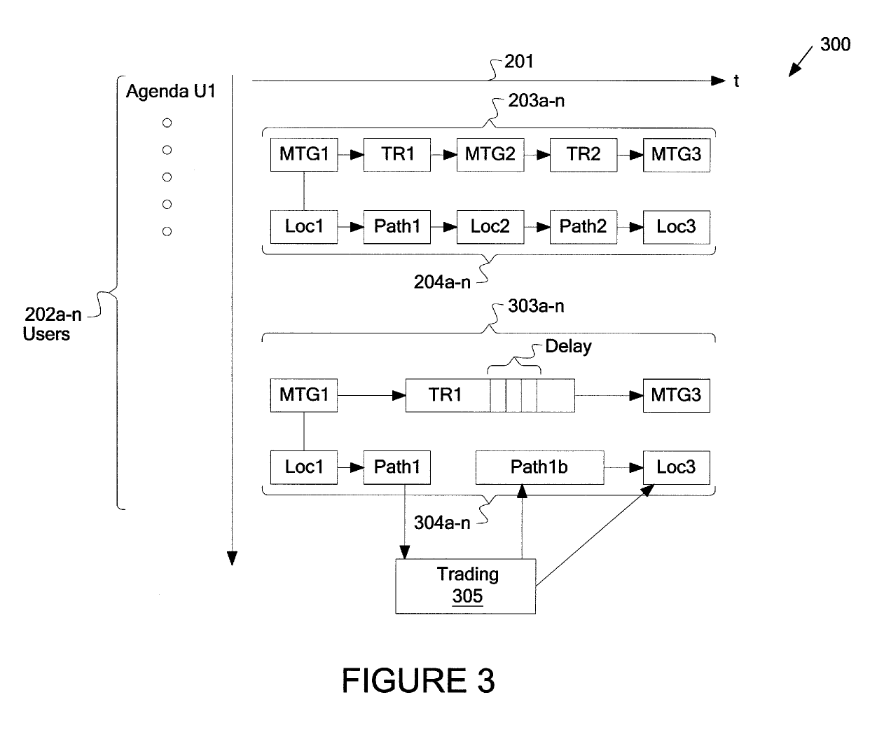

FIG. 3 shows an exemplary calendar system 300 accounting for a variation in actual time of agenda U1 of user 1 202a;

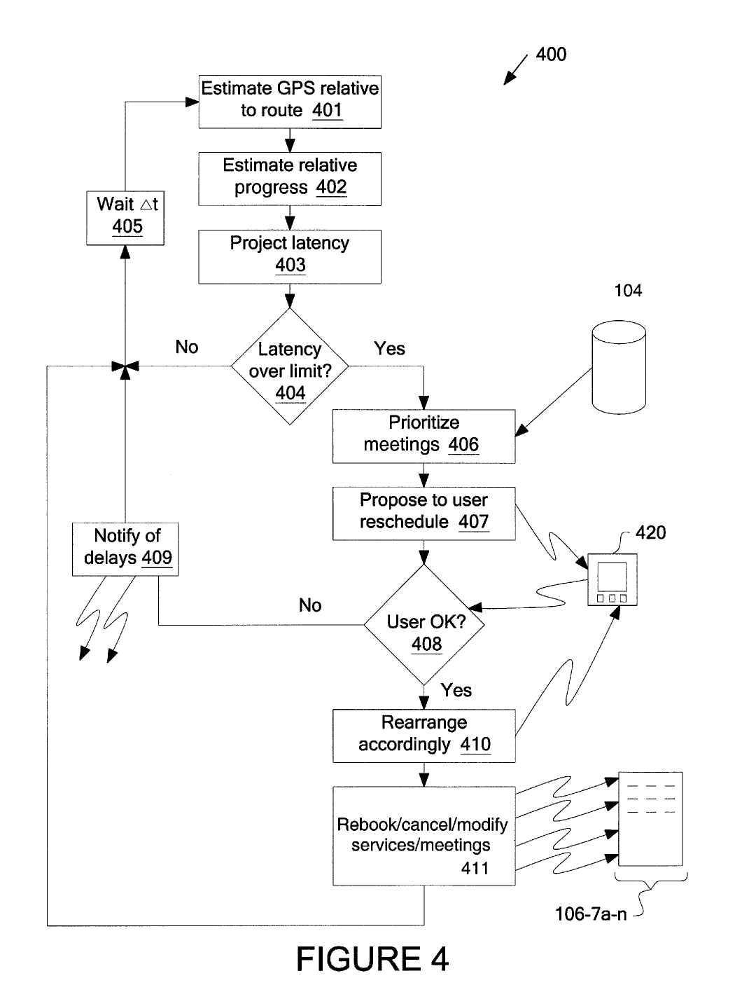

FIG. 4 shows an exemplary process 400 for tracking and rebooking events according to one embodiment of the present invention;

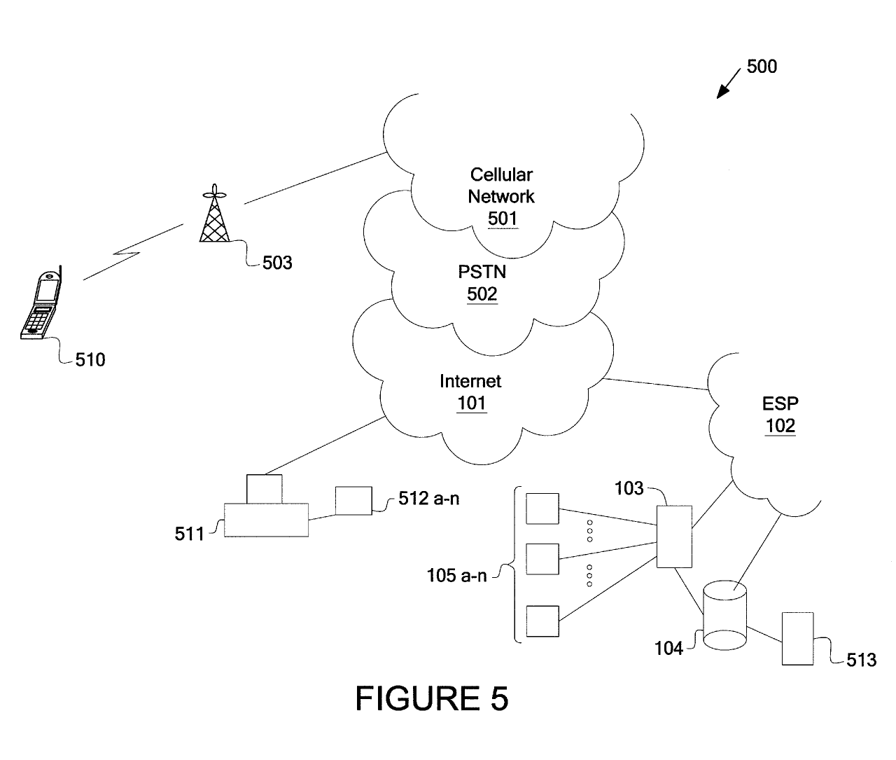

FIG. 5 shows an overview of an exemplary system 500 for automated rescheduling, modification, or cancellation of an event, according to one embodiment of this invention;

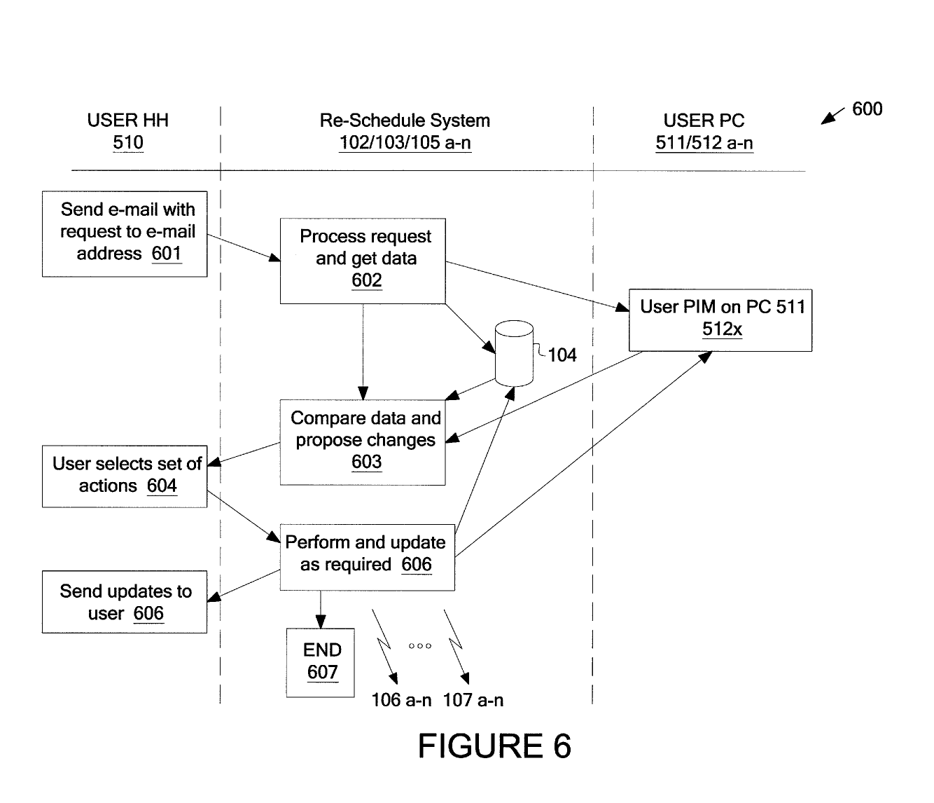

FIG. 6 shows an exemplary time diagram of the notification and rescheduling process 600 according to one embodiment of the current invention; and

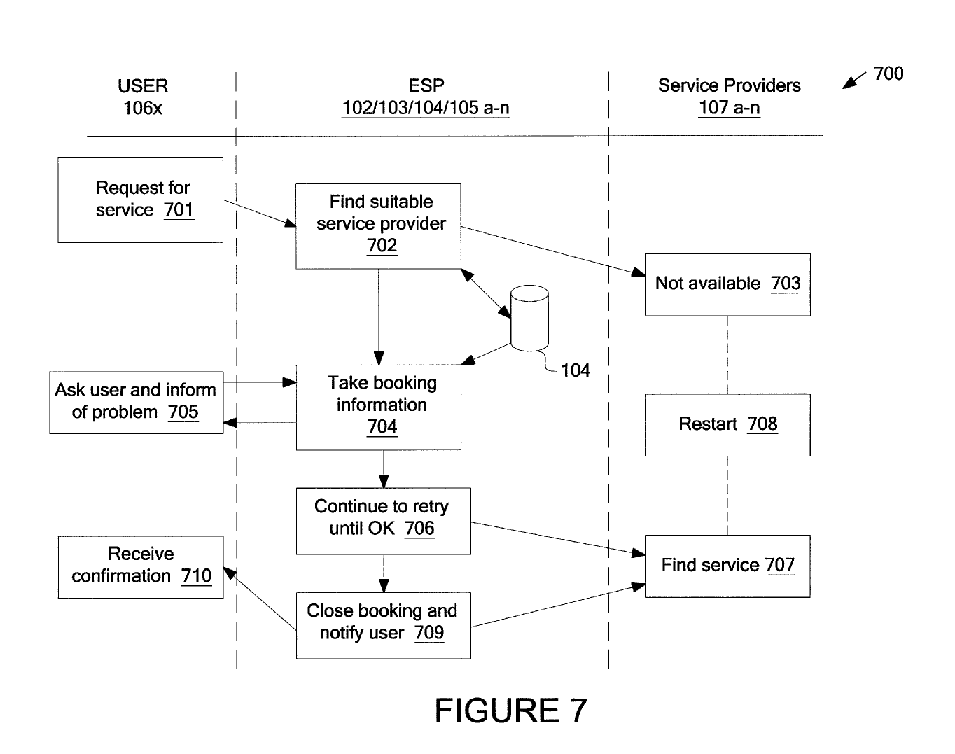

FIG. 7 shows an exemplary time-and-interaction diagram of the transaction process 700 according to one embodiment of the current invention.

### SUMMARY

Some embodiments of the present invention are summarized in this section.

One embodiment provides a method, that may be implemented on a system, for receiving a request from a user to perform at least one of schedule an event or book a transaction; selecting a service provider to schedule the event or book the transaction; contacting the selected service provider to schedule the event or book the transaction; in response to at least one of failure to establish a connection with the selected service provider or failure to receive a response from the selected service provider, notifying the user of the failure and requesting the user submit transaction data to schedule the event or book the transaction with the service provider at a subsequent time; and subsequent to receiving the transaction data from the user, establishing a connection with the selected service provider and using the received transaction data to schedule the event or book the transaction with the selected service provider.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary overview of a system 100 according to one embodiment of the current invention. An electronic services portal ESP 102 connects to a server 103 and a data repository 104. The server hosts software instances 105a-n of the present invention, which, depending on the implementation of the system, may be one, several, or many instances. These software instances are to be considered only exemplary indications of how the software could be installed in server 103 and how it could work in conjunction with ESP 102, personal information managers (PIMs, not shown), and main data repository 104. System 102 connects via Internet 101 to system users 106a-n and suppliers 107a-n. It is clear that these connections could also be through direct connection, through a phone system, or through any other suitable networking method, known or to be invented.

### Proactive Agenda Management

FIG. 2 shows an exemplary overview of a calendar system 200, such as would reside in a PIM or PIM database of many users 202a-n. Shown in detail is an exemplary agenda U1 of user 1 202a (not shown). Along timeline 201 are meetings and transportation events 203a-n, and the locations and movement paths 204a-n associated with events 203a-n. For example, if a meeting MTG1 occurs, and a car TR1 has been ordered to pick up a person at location 1, it is safe to assume that meeting 1 is at or near location 1. The car is also scheduled to deliver the person to location 2, so it is also safe to assume that meeting 2 takes place at or near location 2. Therefore, path 1 may be derived as the most likely path of transportation between location 1 and location 2. Similarly, a person attends meeting 2 and orders car TR2 for transportation along path 2 to meeting 3 at location 3. Tracking can be based on GPS location, time, schedules, and other factors.

FIG. 3 shows an exemplary calendar system 300 accounting for a variation in actual time of agenda U1 of user 1 202a. Transportation TR1 203b is delayed, and thus meetings and the following portions of transportation events 303a-n and locations and movement paths 304a-n are rescheduled. The delay does not allow the following meetings to occur on time. In this example, even though it would have been possible to reschedule meeting 2 and meeting 3, it happens that meeting 3 is of greater importance and a decision has been made to skip meeting 2 and advance the time of meeting 3 as much as is convenient for the other attendee(s).

In some cases, importance can be derived by comparing the relative position of the person(s) to be met in the other company, and the size of the business that is done. In other cases, the user defines importance, for example on a 1-3 scale, or a 1-10 scale. Defaulting based on previous meetings may also be offered. In some cases, a post meeting review may rate the meeting and be used for future meetings as a pre-defined default, or adjusted accordingly.

In some cases, attendees will receive along with the schedule change message an option to vote their preference or decline alternatives, which may or may not be considered.

Tracking software module 305 has observed that transportation TR1 203b did not progress along path 1 from location 1 to location 2 according to schedule using a GPS function of a smart phone device, as is described below in relation to the description of FIG. 4. Module 305 has accordingly initiated communication with the user. As a result the decision was made by either the user or the system based on predefined rules and preferences to cancel meeting 2 and rearrange transportation for meeting 3, and also possibly to rebook meeting.

FIG. 4 shows an exemplary process 400 for tracking and rebooking events according to one embodiment of the present invention. In process 401 the GPS position of the user along the predefined route of the agenda is calculated or determined. The user's GPS position can easily be obtained from any of various newer cell phones, which commonly offer GPS functions. In some cases the GPS data may need to be enabled in the network, so system applications can query the GPS. In other cases, specialized software may be installed in a phone or other GPS device that would allow, for example, only the vendor's software to obtain the tracking data, without broadcasting the data to general phone service providers. In process 402 the current location is compared to the location where the user is supposed to be at the current time and the system estimates the progress of the event, relative to the original agenda. Based on the divergence of the user's actual position from the planned position, and in some cases, factoring in current traffic conditions and other elements affecting progress, the system projects an amount of latency for planned events.

In process 404 the process branches. If the latency is not over a certain limit (no), which may be a predetermined limit or a dynamically calculated limit, the system loops to process 405, where the system waits for a predetermined period of time before continuing back to process 401 to restart. For example, a latency of 15 minutes at a meeting may be acceptable in many cases, so by calculating the current location and the remaining way, you can predict the ETA. Also, traffic condition may be used.

The delay before continuing back to process 401 provides certain granularity to the process, because the system would be over-burdened if it continually processed data on a real-time basis. For example, the system could restart the process every minute, every 5 minutes, every 10 minutes, or after any other suitable period of time. If the latency is over the limit (yes), the system moves to process 406, where it prioritizes meetings based on information obtained from database 104 (e.g., based on predefined rules, historic data and preferences).

Based on the derived priorities, in process 407 the system calculates one or more rescheduling proposals for the user and sends them to the user's communication device 420. This device could receive such a message as an SMS, an IM, an email, as a phone call with a voice interaction system, or by any other suitable means of communication. In some cases, the system could call a designated alternate, if the user does not want to be interrupted or if he is out of reach. In process 408 the user sends a response. If the user does not accept any of the system's proposals (no), the system sends a message in process 409 to other parties, informing them of expected delay times for the next event(s). If the user accepts one of the system's proposals (yes), then in process 410 the system checks arrangements to implement the proposal with other parties 106a-n and suppliers 107a-n as needed and in process 411 it goes about the necessary rebooking, canceling, or modifying services and meetings. For example, in process 410 the system may need to check a flight first, before changing an appointment, etc., in process 411.

Although FIG. 4 shows the confirmation sent to the user in process 410, additional confirmations may also be sent to the user after the system finishes making all arrangements and receiving confirmations from all other parties 106a-n and 107a-n. The system then continues to track the progress of the revised agenda, looping back through the process and making further adjustments if necessary. Although this example shows the delay being caused by transportation problems, it is clear that delays may be caused by any of a wide variety of factors, such as extended meeting times or delays by the user in starting out on the agenda (getting a late start). However, the principles and the proposed automatic rearrangements of schedules are the same in all cases.

### Latency Management Assistant

FIG. 5 shows an overview of an exemplary system 500 for automated rescheduling, modification, or cancellation of an event, according to one embodiment of this invention. A user sends a message, in this example, via mobile electronic communication device 510 to a wireless tower 503. In other cases, such a request could come from any Internet- or other communication-enabled device, including but not limited to PCs, phones both wired and wireless, Internet kiosks, Internet appliances, etc. Typically tower 503 would connect to a cellular network 501 and to either PSTN 502 or Internet 101. The message would then go to electronic services portal ESP 102 or to a user's computer 511. The message then triggers a software instance to contact other parties 106a-n and suppliers 107a-n to make necessary adjustments to accommodate the user's delay. Said software instance could be one of those among software instances 512a-n, which could be, for example, the user's Personal Information Manager (PIM) and associated software to manage interactions between the PIM and the user's message on the user's computer, or software instance 105a-n, which resides on ESP server 103 and uses data repository 104, which repository contains a copy of the user's schedule 513.

FIG. 6 shows an exemplary time diagram of the notification and rescheduling process 600 according to one embodiment of the current invention. In this example, the software instances that accomplish the automated rescheduling reside in the ESP 502. Three columns, left to right, show the three parties in an exemplary rescheduling over time. These parties are the user 510's mobile device in the left column; the rescheduling system components ESP 102, which include server 103, one or more software instances 105a-n, in the center column; and in the right column, the user's computer 511 with its software instances 512a-n. The passage of time during the process is shown proceeding from top to bottom in each column. In process 301, the user sends an email from a hand-held device, such as a mobile phone 510, saying, in effect, that he will be late by some number of minutes, for example, such as 10 minutes, or 30 minutes, and requesting the system to notify, in this case, for example, by electronic communication, the other meeting attendee(s) and service providers.

In process 602, the rescheduling system receives the message. The system retrieves the data it needs to send out notifications, in this case from the user's PIM 512x stored in his PC 511, and/or from data repository 104. In process 603, the system matches its retrieved data to the rescheduling required by the user's delays, and, after processing this data in a similar manner as that discussed earlier, proposes certain changes, which change proposal it sends back to the user's mobile device by email or other suitable form of electronic communication. In process 604, the user selects his desired changes, such as canceling, moving, rescheduling, rebooking, etc. from those proposed by the system and sends his selections back to the system by the same electronic communication means. In process 605, the system implements the user's desired changes and sends messages notifying the other attendee(s) 106a-n and service providers 107a-n of the changes. In process 606 the user receives confirmation of the implemented changes and in process 607 the process ends.

It is clear that many modifications and variations of this embodiment may be made by one skilled in the art without departing from the spirit of the novel art of this disclosure. In particular, in addition to electronic communication means such as email, SMS, IM, etc., messages may also be exchanged by means of a voice XML or IVR system or other, similar automated voice telephone system. In other cases, other suitable, similar messaging media or web interfaces may be offered for interaction with the system to achieve an exchange of information. These variations do not depart from the broader spirit and scope of the invention, and the examples cited here are to be regarded in an illustrative rather than a restrictive sense.

Tentative Booking when Service Providers are Temporarily Unavailable

FIG. 7 shows an exemplary time-and-interaction diagram of the transaction process 700 according to one embodiment of the current invention. In this example, the software instances that accomplish the automated transaction reside in the ESP 102. Alternatively, components of the software instances may reside elsewhere. Three columns, left to right, show the three parties in an exemplary transaction over time. These parties are an exemplary user 106x in the left column; the electronic services portal ESP 102, which contains the services for the present invention and whose components include server 103, the data repository 104, and one or more software instances 105a-n as needed in the center column; and in the right column, one or more service providers 107x-z.

The passage of time during the process is shown proceeding from top to bottom in each column. In process 701, the user sends a request for a transaction, such as, for example, booking a flight, to ESP 102. In process 702, the ESP finds a suitable service provider from among its appropriate service providers 107x-z. The ESP uses its records of user preferences for provider and scheduling and also data about appropriate and available service providers, all drawn from data in data repository 104, as well as accessing data from other sources that may be available, either from other private data stores or from data accessible over the Internet and/or other public networks (not shown).

In process 703, the system finds that the preferred service provider is not responding via electronic communication, for any of various reasons, such as a connectivity problem within the ESP or at the service provider, service-related issues, maintenance-related issues, virus- and worm-related attacks, denial of service (DOS) and similar types of attacks, etc. In such a case, in processes 704 and 705, the ESP interactively requests and takes the transaction information from the user and informs him of the problem of lack of contact with the provider. If possible, the system gives the user an estimate of the time until the lack-of-contact problem is resolved. In process 706, the ESP repeatedly retries making contact with the service provider until it can establish contact. In process 707, the ESP makes contact with the service provider, who has recovered and restarted its system in process 708.

Then in process 709, the transaction is completed and the system notifies the user. In process 710, the user receives confirmation of the transaction. It is clear that if, in process 706, the system receives no response from the selected provider for an extended period of time, the user may be notified, or after a certain time limit has elapsed, such as, for example, less than 24 hours before a planned flight departure time, or less than, for example, less than 2 hours before a car is needed, system may propose and possibly pre-book (as described in relation to the Proactive Agenda Management and Latency Management Assistant) an alternative service to the user. This offer could be made in a manner similar to the manner described in relation to Proactive Agenda Management and Latency Management Assistant.

It is clear that many modifications and variations of this embodiment may be made by one skilled in the art without departing from the spirit of the novel art of this disclosure. For example, the automatic transaction software may not be integrated into the electronic service portal, but rather, it may be a stand-alone software instance made available to users by the ESP, or it may be offered by a third party to deal with communication problems. In other cases, the transaction software may be integrated into the service provider's system to offer better availability of services. These variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
receiving a request from a user to perform at least one of schedule an event or book a transaction;
selecting a service provider to schedule the event or book the transaction;
contacting the selected service provider to schedule the event or book the transaction;
in response to at least one of failure to establish a connection with the selected service provider or failure to receive a response from the selected service provider, notifying the user of the failure and requesting the user submit transaction data to schedule the event or book the transaction with the service provider at a subsequent time; and
subsequent to receiving the transaction data from the user, establishing a connection with the selected service provider and using the received transaction data to schedule the event or book the transaction with the selected service provider.

2. The computer-implemented method of claim 1, further comprising sending to the user confirmation of having scheduled the event or having booked the transaction.

3. The computer-implemented method of claim 2, in response to a predetermined period of time lapsing without establishing a connection with the selected service provider or receiving a response, generating and providing to the user an alternative service provider for scheduling the event or booking the transaction.

4. The computer-implemented method of claim 3, in response to failure to establish a connection with the selected service provider or receive a response within a predetermined period of time before the requested scheduled event or transaction to be booked, generating and providing to the user an alternative service provider for scheduling the event or booking the transaction.

5. The computer-implemented method of claim 4, wherein the selecting the service provider further comprises selecting the service provider based in part on the user's prior established preferences for at least one of service providers or scheduling of events and booking transactions.

6. The computer-implemented method of claim 5, wherein informing the user of the failure to establish a connection or receive a response, further comprises providing an estimate of time to elapse prior to successfully establishing a connection or receiving a response.

7. A machine-readable medium having stored thereon a set of instructions which when executed perform a method comprising:
receiving a request from a user to perform at least one of schedule an event or book a transaction;
selecting a service provider to schedule the event or book the transaction;
contacting the selected service provider to schedule the event or book the transaction;
in response to at least one of failure to establish a connection with the selected service provider or failure to receive a response from the selected service provider, notifying the user of the failure and requesting the user submit transaction data to schedule the event or book the transaction with the service provider at a subsequent time; and
subsequent to receiving the transaction data from the user, establishing a connection with the selected service provider and using the received transaction data to schedule the event or book the transaction with the selected service provider.

8. The machine-readable medium of claim 7, further comprising sending to the user confirmation of having scheduled the event or having booked the transaction.

9. The machine-readable medium of claim 8, in response to a predetermined period of time lapsing without establishing a connection with the selected service provider or receiving a response, generating and providing to the user an alternative service provider for scheduling the event or booking the transaction.

10. The machine-readable medium of claim 9, in response to failure to establish a connection with the selected service provider or receive a response within a predetermined period of time before the requested scheduled event or transaction to be booked, generating and providing to the user an alternative service provider for scheduling the event or booking the transaction.

11. The machine-readable medium of claim 10, wherein the selecting the service provider further comprises selecting the service provider based in part on the user's prior established preferences for at least one of service providers or scheduling of events and booking transactions.

12. The machine-readable medium of claim 11, wherein informing the user of the failure to establish a connection or receive a response, further comprises providing an estimate of time to elapse prior to successfully establishing a connection or receiving a response.

13. A system comprising:
means for receiving a request from a user to perform at least one of schedule an event or book a transaction;
means for selecting a service provider to schedule the event or book the transaction;
means for contacting the selected service provider to schedule the event or book the transaction;
means for notifying the user of the failure and requesting the user submit transaction data to schedule the event or book the transaction with the service provider at a subsequent time, in response to at least one of failure to establish a connection with the selected service provider or failure to receive a response from the selected service provider; and
means for establishing a connection with the selected service provider and using the received transaction data to schedule the event or book the transaction with the selected service provider, subsequent to receiving the transaction data from the user.

14. The system of claim 13, further comprising means for sending to the user confirmation of having scheduled the event or having booked the transaction.

15. The system of claim 14, further comprising means for generating and providing to the user an alternative service provider for scheduling the event or booking the transaction, in response to a predetermined period of time lapsing without establishing a connection with the selected service provider or receiving a response.

16. The system of claim 15, further comprising means for generating and providing to the user an alternative service provider for scheduling the event or booking the transaction, in response to failure to establish a connection with the selected service provider or receive a response within a predetermined period of time before the requested scheduled event or transaction to be booked.

17. The system of claim 16, wherein the means for selecting the service provider further comprises means for selecting the service provider based in part on the user's prior established preferences for at least one of service providers or scheduling of events and booking transactions.

18. The system of claim 17, wherein the means for informing the user of the failure to establish a connection or receive a response, further comprises means for providing an estimate of time to elapse prior to successfully establishing a connection or receiving a response.
